(19) United States
(12) Patent Application Publication
(10) Pub. No.: US 2013/0291332 A1
(43) Pub. Date: Nov. 7, 2013

(54) Cleaning Apparatus

(71) Applicant: Daifuku Co., Ltd., Osaka-shi (JP)

(72) Inventor: Tatsuo Nakao, Hinocho (JP)

(21) Appl. No.: 13/858,263

(22) Filed: Apr. 8, 2013

(30) Foreign Application Priority Data
Apr. 9, 2012 (JP) 2012-088493

(51) Int. Cl. B08B 5/02

(52) U.S. Cl. CPC B08B 5/023
USPC 15/347

(57) ABSTRACT

A cleaning apparatus is provided which can prevent dust from being dispersed into the surrounding area. The cleaning apparatus comprises a cover member which covers the cleaning target location of the article support platform, a blower which moves air toward the cleaning target location within an area surrounded by the cover member, and a dust collector which collects dust that is lifted by movement of air caused by the blower.

### FIELD OF THE INVENTION

The present invention relates to cleaning apparatus including a supported member adapted to be supported by a support member of an article transport vehicle, the support member being configured to support an article and to place the article supported by the support member on an article support platform when the support member is lowered, the cleaning apparatus being configured to clean a cleaning target location on a top surface of the article support platform with the cleaning apparatus placed on the article support platform as a result of a lowering of the support member with the supported member supported by the support member.

### BACKGROUND

Cleaning apparatus is provided to clean cleaning target locations on top surfaces of article support platforms to which articles are transported by article transport vehicles. Such cleaning apparatus includes a supported member which is supported by a support member of an article transport vehicle so that the cleaning apparatus can be transported to a cleaning target location by means of an article transport vehicle for transporting articles.

And an example of such cleaning apparatus includes sweep out members for sweeping out dust which exists in a cleaning target location and is configured to sweep out dust from the cleaning target location to clean the cleaning target location by moving the sweep out members horizontally by projecting and retracting the transfer device provided to the article transport vehicle with the sweep out members kept in contact with the cleaning target location. (See, for example, JP Utility Model Publication No. H06-061814 (Patent Document 1.)

However, since the above-described cleaning apparatus is configured area, there was a problem of the dispersed dust falling to the floor and generally contaminating the area surrounding the cleaning target location.

### SUMMARY OF THE INVENTION

In view of the state of the art described above, a cleaning apparatus is desired which can prevent dust from being dispersed into the surrounding area.

To this end, there is provided a cleaning apparatus including a supported member adapted to be supported by a support member of an article transport vehicle, the support member being configured to support an article and to place the article supported by the support member on an article support platform when the support member is lowered, the cleaning apparatus being configured to clean a cleaning target location on a top surface of the article support platform with the cleaning apparatus placed on the article support platform as a result of a lowering of the support member with the supported member supported by the support member, wherein the cleaning apparatus in accordance with the present invention comprises: a cover member which covers the cleaning target location of the article support platform; a blower which moves air toward the cleaning target location within an area surrounded by the cover member while the cleaning target location is covered by the cover member; and a dust collector which collects dust that is lifted by movement of air caused by the blower.

As such, the cleaning apparatus that is assigned to clean an article support platform is unloaded onto the article support platform with a lowering of the support member while the cleaning apparatus is supported by the support member of the article transport vehicle. And the cleaning apparatus that has finished cleaning the article support platform is received from the article support platform with a raising of the support member while the cleaning apparatus is supported by the support member of the article transport vehicle. Thus, the cleaning apparatus is configured to be transported to an article support platform by an article transport vehicle for transporting articles.

And with the cleaning target location covered by the cover member after the cleaning apparatus is unloaded onto the article support platform, dust in the cleaning target location on the top surface of the article support platform is lifted within the cover member by moving air toward the cleaning target location with the blower. And since the dust that is lifted is collected by the dust collector, dust is prevented from being dispersing into the surrounding area.

Examples of preferred embodiments in accordance with the present invention are described next.

In an embodiment of the cleaning apparatus in accordance with the present invention, the dust collector is preferably located in dust collection space defined above the blower, wherein the blower is preferably configured to draw in air from the dust collection space to cause the air to pass through the dust collector and to move the air toward the cleaning target location located below the blower, and wherein an air guiding path is preferably provided for guiding the air moved toward the cleaning target location through an area lateral of the blower and to the dust collection space.

As such, the air moved toward the cleaning target location by the blower is drawn in by the cleaning apparatus and is moved toward the cleaning target location after being guided through an area lateral to the blower and to the dust collection space. In other words, the air that is moved toward the cleaning target location by the blower and that carries lifted dust passes through the dust collector in the dust collection space thereby dust is collected. And the air is then moved toward the cleaning target location again by the blower. Thus, the cleaning apparatus is configured such that air is circulated within the cover member to collect dust; so, there is no need to provide the cover member with an air supply inlet for supplying air into the interior space from exterior space, or an air discharge outlet for discharging air from the interior space to the exterior space. Thus, the structure of the cover member may be simplified.

In an embodiment of the cleaning apparatus in accordance with the present invention, a lower end portion of the cover member is preferably configured to be deformed to conform to a shape of a top surface of the article support platform in order to block off interior space of the cover member from exterior space.

More specifically, because the lower end portion of the cover member can be deformed to conform to the shape of the top surface of the article support platform even when the top surface of an article support platform is uneven, the cleaning apparatus placed on the article support platform can be prevented from being placed in a tilted attitude as a result of settling on the unevenness formed in the top surface of the article support platform. Thus, the cleaning apparatus can be placed on the article support platform in an attitude suitable for cleaning even when the top surface of the article support platform is uneven, thereby facilitating proper cleaning of the cleaning target location.

In an embodiment of the cleaning apparatus in accordance with the present invention, the blower is preferably a fan filter unit having a dust filter for removing dust and a blower fan for moving air toward the cleaning target location through the dust filter wherein the dust filter and the blower fan are preferably assembled into an integral unit.

As such, since air is moved toward the cleaning target location through the dust filter, dust that was not collected by the dust collector can be removed by the dust filter. Thus, clean air can be supplied to the cleaning target location, and the cleaning target location can be cleaned properly.

And since only the fan filter unit in which the dust filter and the blower fan are assembled into an integral unit is required to function as a blower, the installation of the blower having the dust filter and the blower fan is facilitated.

In an embodiment of the cleaning apparatus in accordance with the present invention, the blower preferably includes a blower fan which is rotated about a vertical axis wherein the blower is preferably located at a position spaced apart upwardly from the cleaning target location when the cleaning apparatus is placed on the article support platform, wherein a lower end surface of the blower is preferably covered with a perforated plate-shaped member.

As such, the lower end surface of the blower is covered with a perforated plate-shaped member so that a chamber in which air may accumulate is formed between the blower and the plate-shaped member. Thus, even when the area of the cleaning target location is large relative to the blower fan, uniform air flow is supplied over a wide area in the cleaning target location because of the function of the chamber.

In an embodiment of the cleaning apparatus in accordance with the present invention, it is preferable to include a controller for controlling operation of the blower, a battery for supplying electric power to the blower, and a move detecting device which detects that the cleaning apparatus has been moved onto, or placed on, the article support platform, wherein the controller is preferably configured to control operation of the blower in order to start an operation of the blower when the move detecting device detects that the cleaning apparatus has been moved onto the article support platform and to stop the operation of the blower after a set period has elapsed since the start of the operation of the blower.

As such, since the battery is provided, it is not necessary to provide, for example, electricity supply lines for supplying electric power to the cleaning apparatus from the article transport vehicle, thereby facilitating the handling of the cleaning apparatus. And the blower is operated when the move detecting device detects that the cleaning apparatus has been moved onto the article support platform.

And the operation of the blower is stopped after the set period elapses since the start of the operation of the blower. Thus, the operation of the blower is suspended before it is moved onto the article support platform and after a set period has elapsed that is required to clean the cleaning target location after it is moved onto the article support platform. This function helps save electric power.

### BRIEF DESCRIPTION OF THE DRAWINGS

FIG. 1 is a lateral side view of an article transport facility,

FIG. 2 is another lateral side view of the article transport facility,

FIG. 3 is a side view of a ceiling transport vehicle that is supporting an article container in a transport position,

FIG. 4 is a side view of the ceiling transport vehicle that is in the process of lowering the article container from the transport position,

FIG. 5 is a side view of the ceiling transport vehicle that is supporting a cleaning apparatus in the transport position,

FIG. 6 is a partial cut-out side view of the cleaning apparatus,

FIG. 7 is a control block diagram,

FIG. 8 shows how a cleaning operation is performed,

FIG. 9 also shows how a cleaning operation is performed,

FIG. 10 also shows how a cleaning operation is performed, and

FIG. 11 is a partial cut-out side view of a cleaning apparatus in accordance with an alternative embodiment.

### DETAILED DESCRIPTION

Embodiments of an article transport facility having a cleaning apparatus in accordance with the present invention are described next with reference to the drawings.

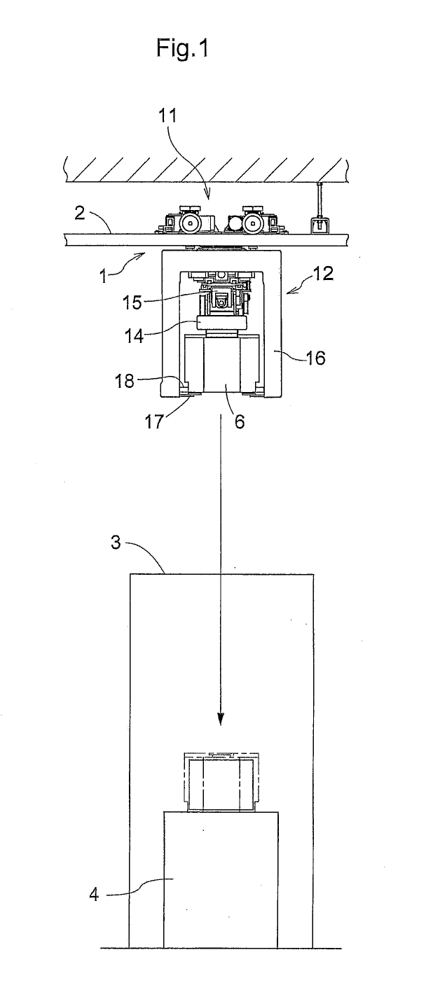

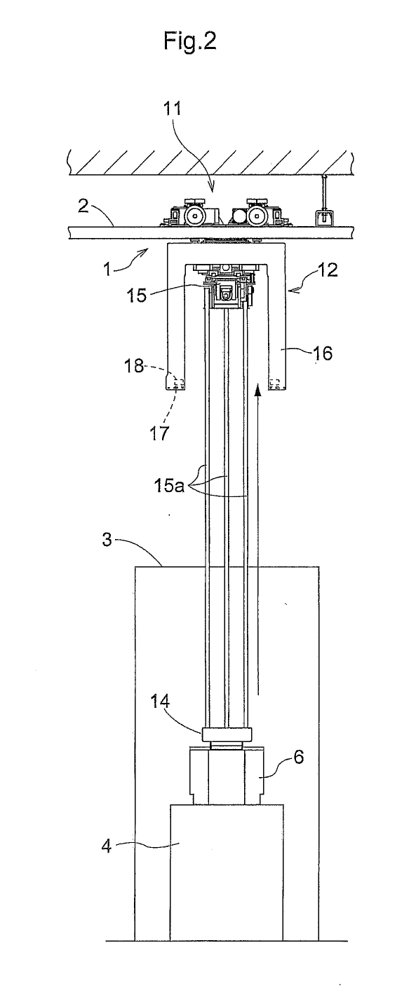

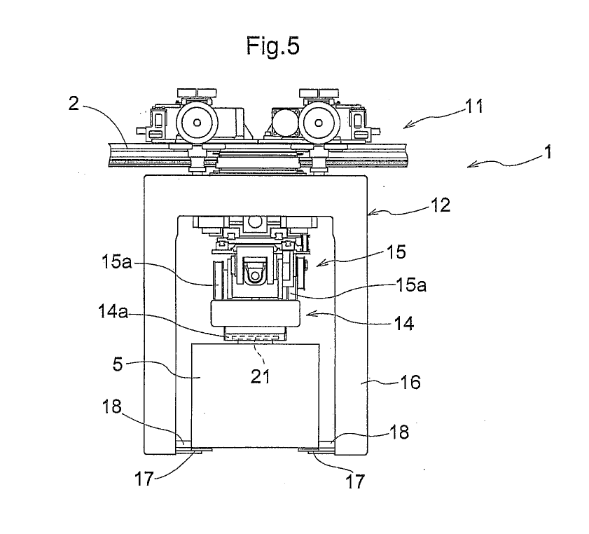

As shown in FIGS. 1-5, the article transport facility includes ceiling transport vehicles 1 that function as article transport vehicles which can travel along a travel path with each transport vehicle guided and supported by travel rails 2 provided to the ceiling, article support platforms 4 provided on the floor with each platform 4 located near each processing device 3 for processing substrates, and cleaning apparatus 5 (see FIG. 5) for cleaning the top surfaces of the article support platforms 4.

Substrate containers 6 each of which house and carry a number of substrates, more specifically, FOUPs (Front Opening Unified Pod) for housing and carrying semiconductor wafers, are transported as articles.

A top flange 7, which is configured to be supported by a support mechanism 14 which functions as a support member of the ceiling transport vehicle 1, is formed on the top surface of each substrate container 6. And container recessed portions, with which projections provided to each article support platform 4 engage, are formed in the bottom surface of each substrate container 6.

### [Ceiling Transport Vehicle]

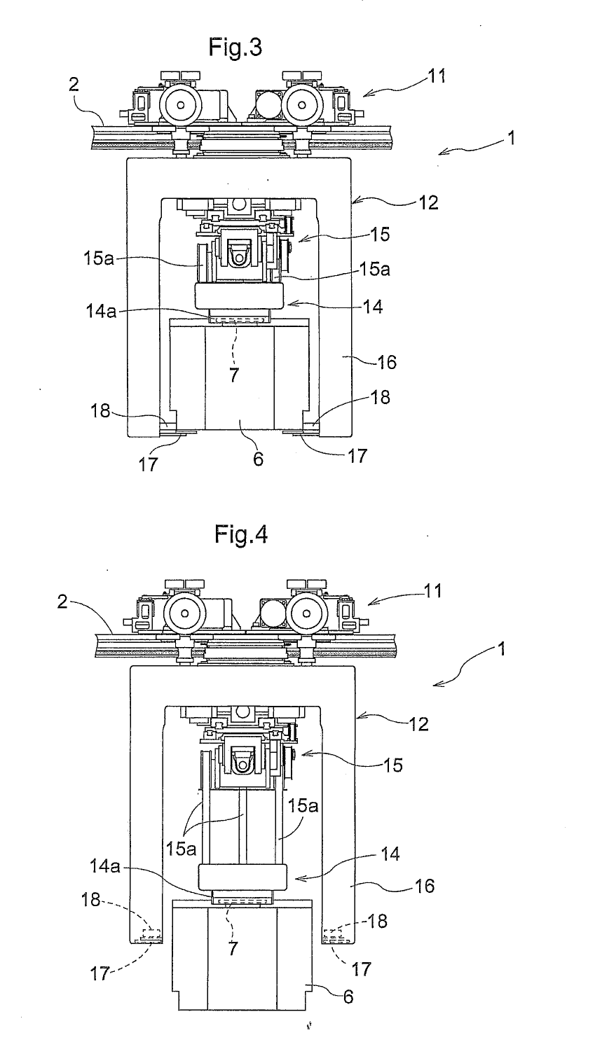

As shown in FIGS. 3 and 4, each ceiling transport vehicle 1 includes a travel portion 11 which travels on the travel rails 2 along the travel path, and a main body portion 12 which is suspended and supported by the travel portion 11 such that it is located under the travel rails 2, and which supports a substrate container 6 such that the substrate container 6 can be raised and lowered, or vertically moved.

The main body portion 12 includes the support mechanism 14 for supporting the substrate container 6, a vertically moving mechanism 15 for vertically moving the support mechanism 14, a cover portion 16 which covers the area above the substrate container 6 located in the transport position as well as areas to the front and back of the substrate container 6 in a travel path longitudinal direction, fall prevention members 17 for preventing the substrate container 6 supported by the support mechanism 14 from falling, and sway prevention members 18 for preventing or reducing swaying motion of the substrate container 6 supported by the support mechanism 14.

The support mechanism 14 includes a pair of gripping claws or arms 14a each of which can be pivoted about a laterally or horizontally extending axis. The pair of gripping claws 14a are configured such that their attitudes or positions can be changed between gripping attitudes in which the gripping claws 14a are pivoted toward each other to grip the top flange 7 of the substrate container 6, and release attitudes in which the gripping claws 14a are pivoted away from each other to release the grip on the top flange 7.

The vertically moving mechanism 15 is configured to spool and feed out spool belts 15a whose ends are connected to the support mechanism 14 to support it, and is configured to raise and lower, or vertically move, the support mechanism 14 by spooling and feeding out the spool belts 15a. As shown in FIG. 1, when the spool belts 15a are spooled or retracted, the substrate container 6 supported by the support mechanism 14 is located within the cover portion 16. The position at which the substrate container 6 is located within the cover portion 16 is defined to be the transport position.

The fall prevention members 17 are configured to be moved between respective receiving positions (see FIG. 3) in which the fall prevention members 17 are located directly under the substrate container 6 in the transport position and respective retracted positions (see FIG. 4) in which the fall prevention members 17 are retracted away from the vertical movement path traced by the substrate container 6 as it is vertically moved by the support mechanism 14. And by positioning the fall prevention members 17 in their receiving positions, the substrate container 6 can be received by the fall prevention members 17 even if the support mechanism 14 fails to maintain support of the substrate container 6 during travel of the ceiling transport vehicle 1. This arrangement prevents the substrate container 6 from falling. On the other hand, by positioning the fall prevention members 17 in their retracted positions, the substrate container 6 can be unloaded onto and received from an article support platform 4 by vertically moving the support mechanism 14.

The sway prevention members 18 are configured to be moved between respective contact positions (see FIG. 3) in which the sway prevention members 18 are in contact, from both sides in the travel path longitudinal direction, with the substrate container 6 located in the transport position, and respective spaced apart positions (see FIG. 4) in which the sway prevention members 18 are spaced away from each other in the travel path longitudinal direction and away from the substrate container 6 located in the transport position. And swaying of the substrate container 6 during travel of the ceiling transport vehicle 1 can be prevented by positioning the sway prevention members 18 in their contact positions. And by positioning the sway prevention members 18 in their spaced apart positions, the substrate container 6 can be unloaded onto and received from an article support platform 4 by vertically moving the support mechanism 14.

When the ceiling transport vehicle 1 travels with the substrate container 6 supported by the support mechanism 14, the spool belts 15a are spooled, the gripping claws 14a are in the gripping attitudes to grip and hold the substrate container 6, the fall prevention members 17 are in their receiving positions, and the sway prevention member 18 are in their contact positions. The substrate container 6 is in the transport position at this time.

In addition, when the ceiling transport vehicle 1 travels without any substrate container 6 supported by the support mechanism 14, the spool belts 15a are spooled, the gripping claws 14a are in the release attitudes, the fall prevention member 17 are in their retracted positions, and the sway prevention members 18 are located in their spaced apart positions.

And when the ceiling transport vehicle 1 unloads the substrate container 6 to an article support platform 4, the fall prevention members 17 are moved to their retracted positions and the sway prevention members 18 are moved to their spaced apart positions with the ceiling transport vehicle 1 stopped at a stop position that corresponds to the article support platform 4. And the spool belts 15a are fed out to lower the support mechanism 14 supporting the substrate container 6 and to place the substrate container 6 on the article support platform 4. And then the gripping claws 14a are moved to the grip release attitudes to release the grip on the substrate container 6. Subsequently, the spool belts 15a are spooled to raise the support mechanism 14 which no longer supports any substrate container 6. This is how a substrate container 6 is unloaded onto an article support platform 4.

In addition when the ceiling transport vehicle 1 receives a substrate container 6 from an article support platform 4, the support mechanism 14 which is not supporting any substrate container 6 is lowered by feeding out the spool belts 15a with the ceiling transport vehicle 1 stopped directly above the article support platform 4; thereafter, the gripping claws 14a are moved to the gripping attitudes to grip the substrate container 6 placed on the article support platform 4. Subsequently, the spool belts 15a are spooled, the support mechanism 14 which now suspends and supports the substrate container 6 is raised, the fall prevention members 17 are moved to their receiving positions, and the sway prevention members 18 are moved to their contact positions. And this is how a substrate container 6 is received from an article support platform 4.

Thus, the ceiling transport vehicle 1 is configured to unload a substrate container 6 to an article support platform 4 by lowering the support mechanism 14, and to receive a substrate container 6 from an article support platform 4 by raising the support mechanism 14. In addition, the ceiling transport vehicle 1 is configured to place a substrate container 6 supported by the support mechanism 14 on the article support platform 4 by lowering the support mechanism 14 for supporting an article when unloading a substrate container 6.

In addition, a cleaning target location (or area) E to be cleaned by the cleaning apparatus 5 is defined on the top surface of each article support platform 4. More specifically, the cleaning target location E is defined such that three projections for engaging a substrate container 6 are located within the cleaning target location E. In other words, the three projections are provided in the cleaning target location E on the top surface of the article support platform 4.

### [Cleaning Apparatus]

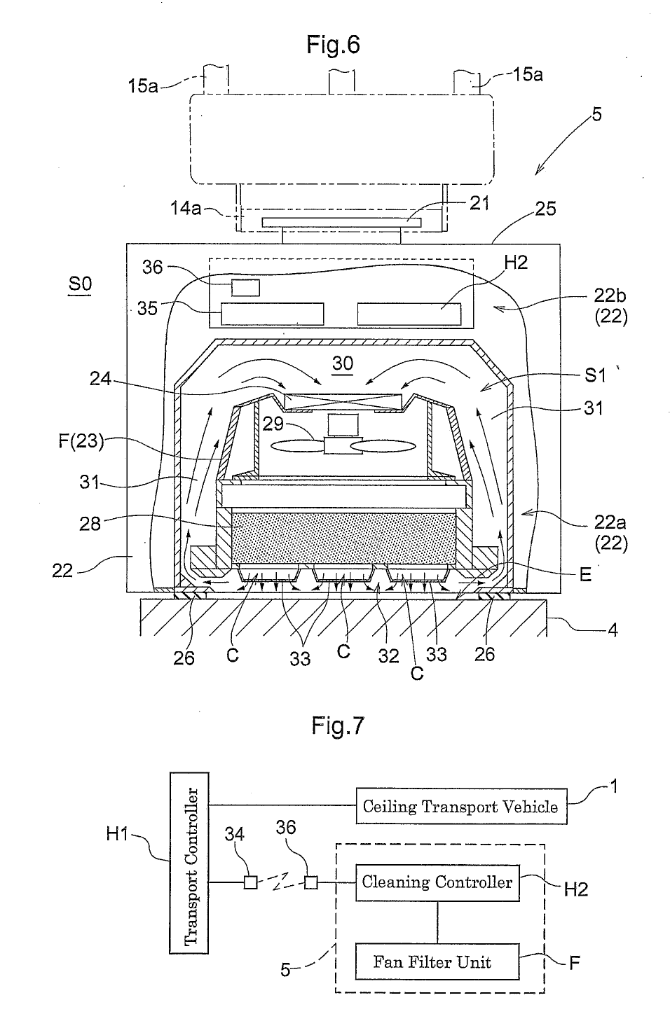

As shown in FIG. 6, the cleaning apparatus 5 has a supported member 21 adapted to be supported by the support mechanism 14 of the ceiling transport vehicle 1, and is configured to be moved onto, or place on, the article support platform 4 as the support mechanism 14 is lowered with the supported member 21 supported by the support mechanism 14. And the cleaning apparatus 5 is configured to clean the cleaning target location E on the top surface of the article support platform 4 while the cleaning apparatus 5 is located on the article support platform 4.

In addition, the cleaning apparatus 5 is configured such that its external shape is formed to fit within the cover portion 16 of the ceiling transport vehicle 1, and to be transported by a ceiling transport vehicle 1 similarly to the substrate containers 6. More specifically, the ceiling transport vehicle 1 travels with the supported member 21 supported by the support mechanism 14 and with the cleaning apparatus 5 located in the transport position. And the cleaning apparatus 5 is unloaded onto the article support platform 4 by lowering the support mechanism 14 with the supported member 21 supported by the support mechanism 14. And the cleaning apparatus 5 is received from the article support platform 4 by raising the support mechanism 14 with the supported member 21 supported by the support mechanism 14.

The cleaning apparatus 5 includes a cover member 22 for covering the cleaning target location E of the article support platform 4, a blower 23 for moving or blowing air toward the cleaning target location E and in the area surrounded by the cover member 22 while the cleaning target location E is covered by the cover member 22, and a dust collector 24 for collecting dust lifted off the surface, or picked up, by the air flow from the blower 23.

The cover member 22 includes a lower portion 22a which defines an interior space S1, and an upper portion 22b in which a battery 35, among other things, is located. The lower portion 22a is formed such that it is closed on all sides and above but is open downwardly to define the interior space S1 within. In addition, the lower part of the lower portion 22a has a shape of a rectangular tube. And its upper part tapers toward the top so that the cross-sectional area of the interior space S1 becomes smaller toward the top.

And the cover member 22 is provided to the cleaning apparatus 5 so as to cover the cleaning target location E from above when the cleaning apparatus 5 is placed on the article support platform 4. The supported member 21 adapted to be supported by the support mechanism 14 of the ceiling transport vehicle 1 is connected to the cover member 22 in the central area of the top surface of its top plate 25.

At least one deformable member 26 which can be deformed at least in the vertical direction is provided to the undersurfaces of the peripheral walls of the lower portion 22a so as to extend all the way along the undersurfaces. This deformable member 26 is made of sponge rubber, which is elastically deformable. Thus, the lower end portion of the cover member 22 is configured to be able to be deformed to conform to the top surface of the article support platform 4 in order to block off the interior space S1 of the cover member 22 from the exterior space S0 (space outside the cover member 22).

The blower 23 is a fan filter unit F which includes a dust filter 28 for removing dust and a blower fan 29 for moving air toward the cleaning target location E through the dust filter 28, with the dust filter 28 and the fan 29 being assembled into an integrated unit.

The fan filter unit F is located in the interior space S1 of the cover member 22 such that the fan filter unit F is spaced apart downwardly from the top plate 25 of the cover member 22, is spaced apart from the peripheral walls of the cover member 22 in lateral or horizontal directions (or inwardly from each peripheral wall), and is spaced apart upwardly from the cleaning target location E when the cleaning apparatus 5 is placed on the article support platform 4. And dust collection space 30 is formed above the fan filter unit F in the interior space S1. And air guiding paths 31 are formed laterally of the fan filter unit F in the interior space S1 (i.e., between the fan filter unit F and the inner peripheral wall surfaces) for guiding air blown toward the cleaning target location E through areas lateral of the fan filter unit F and to the dust collection space 30.

The dust collector 24 is located in the dust collection space 30 such that the dust collector 24 covers the top side of the fan filter unit F. This dust collector 24 is made of permeable material such as paper, has a shape of a bag that has an opening on the upstream side in the air flow direction, and is configured to collect dust in the dust collector 24 from the air that passes through the dust collector 24. Incidentally, the dust collector 24 is configured to be removable so that it can be replaced.

In addition, the lower end surface of the fan filter unit F is covered with perforated plate-shaped members 33. The plate-shaped members 33 are so configured and located to cover the undersurface side of the fan filter unit F, and are shaped to project, or bulge, downwardly from the fan filter unit F. This arrangement allows a chamber C to be formed between the dust filter 28 of the fan filter unit F and each plate-shaped member 33.

The fan filter unit F is supported by the cover member 22 such that the blower fan 29 is rotated about a vertical axis. And the fan filter unit F is configured to draw in air from the dust collection space 30 above the fan filter unit F when the blower fan 29 is rotated, and to move air toward the cleaning target location E below the fan filter unit F.

The air supplied toward the cleaning target location E below by the blower fan 29 is clean after fine dust that was not collected by the dust collector 24 is removed by the dust filter 28. In addition, even if pulsation occurs in the air supplied from the blower fan 29, the pulsation is diminished with the function of chambers C so that uniform air flow is supplied over a wide area in the cleaning target location E.

The air blowing function of the fan filter unit F ensures that there is negative pressure in the dust collection space 30 above the fan filter unit F and there is positive pressure in the air flow space 32 below the fan filter unit F (i.e., space above the cleaning target location E). This causes air in the air flow space 32 to flow through the air guiding paths 31 and into the dust collection space 30. The dust in the cleaning target location E is lifted off the surface and carried to the dust collection space 30 by the supply of air to the cleaning target location E by the fan filter unit F and the flow of air from the air flow space 32 to the dust collection space 30. And the dust carried to the dust collection space 30 is collected by the dust collector 24.

Thus, air is circulated within the cover member 22 by the air moving function of the fan filter unit F to lift the dust in the cleaning target location E and within the cover member 22 to collect dust by the dust collector 24.

### [Controller]

As shown in FIG. 7, a transport controller H1 which functions as a controller for controlling the operation of the ceiling transport vehicle 1 is provided in the article transport facility.

The transport controller H1 is configured to control operation of the ceiling transport vehicle 1 in order to perform an unloading operation in which a substrate container 6 is unloaded onto an article support platform 4, a receiving operation in which a substrate container 6 is received from an article support platform 4, and a cleaning operation in which the ceiling transport vehicle 1 receives the cleaning apparatus 5 from an article support platform 4 after a predetermined waiting period has elapsed after unloading the cleaning apparatus 5 onto the article support platform 4.

In the unloading operation, with the ceiling transport vehicle 1 supporting a substrate container 6 stopped at a stop position corresponding to an article support platform 4, the fall prevention members 17 are moved to their retracted positions, the sway prevention members 18 are moved to their spaced apart positions, and the gripping claws 14a are moved to the release attitudes after the spool belts 15a are fed out to unload the substrate container 6 onto the article support platform 4. Subsequently, the spool belts 15a are spooled back.

In the receiving operation, with the ceiling transport vehicle 1 that does not support any substrate container 6 stopped at a stop position corresponding to an article support platform 4, the gripping claws 14a are moved to the gripping attitudes after the spool belts 15a are fed out to receive a substrate container 6 from the article support platform 4. Subsequently, the spool belts 15a are spooled, the fall prevention members 17 are moved to their receiving positions, and the sway prevention members 18 are moved to their contact positions.

In the unloading operation, the cleaning apparatus 5 to be unloaded to the article support platform 4 is transported from a storage section for storing the substrate container 6 or from storage for exclusively storing the cleaning apparatus 5. And in the receiving operation, the cleaning apparatus 5 received from the article support platform 4 is transported to a storage section or the storage.

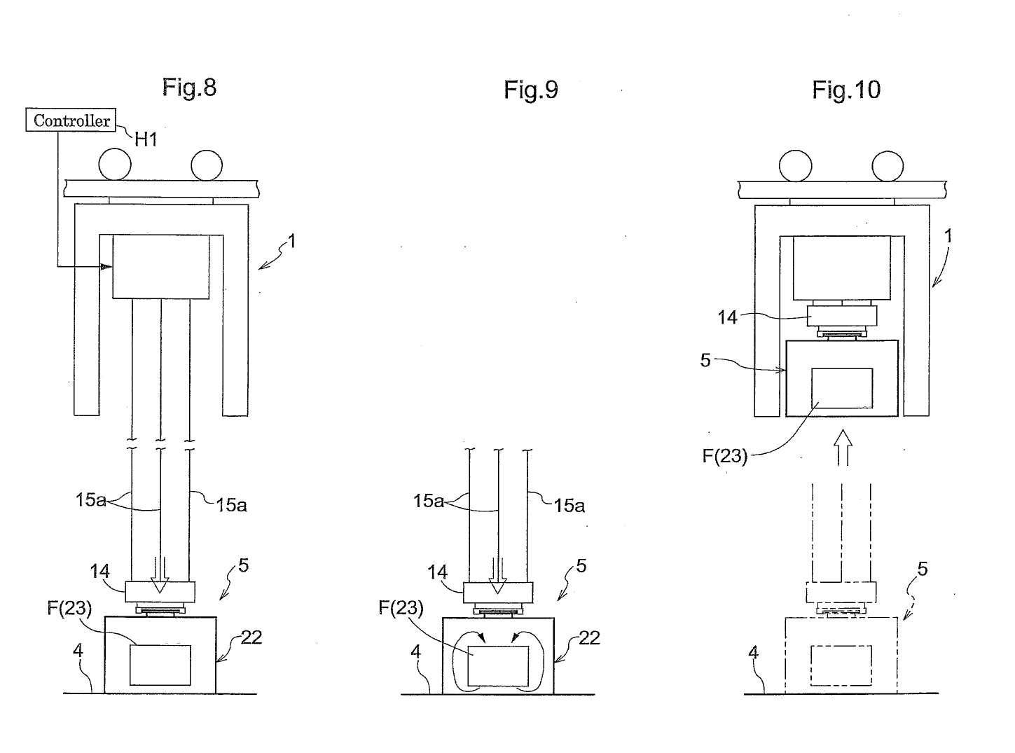

In the cleaning operation, as shown in FIG. 8, with the ceiling transport vehicle 1 supporting the cleaning apparatus 5 stopped at a stop position corresponding to an article support platform 4, the fall prevention members 17 are moved to their retracted positions, the sway prevention members 18 are moved to their spaced apart positions, and the spool belts 15a are fed out to place the cleaning apparatus 5 on the article support platform 4. And as the cleaning apparatus 5 is unloaded onto the article support platform 4, unload complete information which indicates that the cleaning apparatus 5 has been unloaded onto the article support platform 4 is transmitted to the cleaning apparatus 5 from a transmitter 34.

In addition, in the cleaning operation, as shown in FIG. 10, with the ceiling transport vehicle 1 that does not support any substrate container 6 stopped at a stop position corresponding to an article support platform 4, the spool belts 15a are fed out in order to receive the cleaning apparatus 5 from the article support platform 4 after a waiting period for cleaning has elapsed after transmitting the unload complete information to the cleaning apparatus 5. And the gripping claws 14a are moved to the gripping attitudes to receive the cleaning apparatus 5 from the article support platform 4. Subsequently, the spool belts 15a are spooled, and the fall prevention members 17 are moved to their receiving positions, and the sway prevention members 18 are moved to their contact positions.

The cleaning apparatus 5 is provided with a cleaning controller H2 that functions as a controller for controlling the operation of the fan filter unit F (blower fan 29), a battery 35 which supplies electric power to the fan filter unit F (i.e., to the electric motor which drivingly rotates the blower fan 29), and a receiver 36 which receives the unload complete information transmitted from the transmitter 34.

As shown in FIG. 9, the cleaning controller H2 is configured to control operation of the fan filter unit F in order to start the operation of the fan filter unit F when the receiver 36 receives the unload complete information from the transport controller H1 and to stop the operation of the fan filter unit F after a set period has elapsed since the start of the operation of the fan filter unit F.

As such, the cleaning apparatus 5 operates the fan filter unit F to clean the cleaning target location E after being unloaded onto the article support platform 4 by the ceiling transport vehicle 1 and stops the operation of the fan filter unit F after the set period has elapsed since the start of the operation of the fan filter unit F. After the operation of the fan filter unit F is stopped, the cleaning apparatus 5 is received by a ceiling transport vehicle 1 that is different from the ceiling transport vehicle 1 that unloaded the cleaning apparatus 5 onto the article support platform 4.

Note that the set period is defined to be shorter than the waiting period for cleaning.

In addition, the receiver 36 is a device that receives the unload complete information which is transmitted as the cleaning apparatus 5 is moved onto the article support platform 4, and functions as a move detecting device which detects that the cleaning apparatus 5 has been moved onto, or placed on, the article support platform 4.

Thus, the cleaning apparatus 5 is unloaded onto the article support platform 4 by a ceiling transport vehicle 1 for transporting the substrate containers 6. And by operating the fan filter unit F, the dust in the cleaning target location E on the article support platform 4 is lifted off the surface within the cover member 22 and is collected by the dust collector 24. Thus, when the cleaning target location E is cleaned by the cleaning apparatus 5, dust is not dispersed into the surrounding area.

### Alternative Embodiments

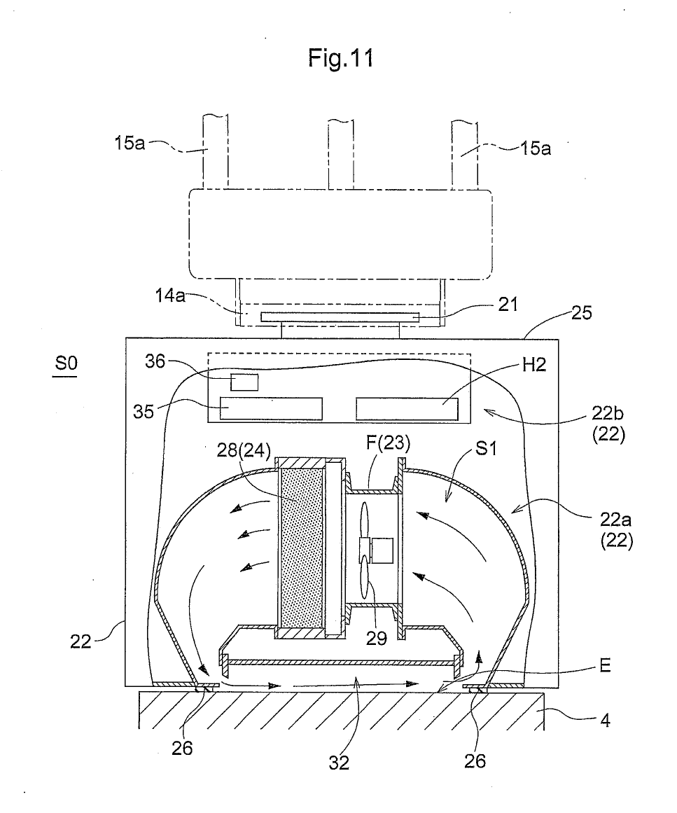

(1) In the embodiment described above, the dust collector 24 is provided separately, and in addition to, the dust filter 28 of the fan filter unit F. However, as shown in FIG. 11, the dust filter 28 of the fan filter unit F may also function as the dust collector 24.

In addition, although air is moved from directly above onto the cleaning target location E in the embodiment described above, air may be moved from a lateral side, or horizontally, onto the cleaning target location E as shown in FIG. 11.

(2) In the embodiment described above, air is circulated within the cover member 22. However, a venting portion through which air can flow from the interior space S1 to the exterior space S0 may be provided to the cover member 22, and a blower 23 may be provided to the cover member 22 for moving air from the exterior space S0 into the interior space S1 so that air is not circulated within the cover member 22. Incidentally, the dust collector 24 is provided to the venting portion when this arrangement is adapted.

(3) In the embodiment described above, the blower fan 29 is provided to the blower 23 such that the blower fan 29 is rotated about a vertical axis. However, as shown in FIG. 11, the blower fan 29 may be provided to the blower 23 such that the blower fan 29 is rotated about a laterally, or horizontally, extending axis.

In addition, in the embodiment described above, the blower 23 is the fan filter unit F that has the blower fan 29 and the dust filter 28 that are assembled into an integral unit. However, the blower 23 may consists only of the blower fan 29. In addition, even when the blower 23 includes the blower fan 29 and the dust filter 28, the blower fan 29 and the dust filter 28 may be individually and separately attached to the cover member 22.

(4) In the embodiment described above, the deformable member 26 is made of sponge rubber so that the lower end portion of the cover member 22 can be deformed to conform to the top surface of the article support platform 4. However, the way to allow the lower end portion of the cover member 22 to be deformed may be modified appropriately. For example, two or more bar-shaped or plate-shaped closing members may be provided in the lower end portion of the cover member 22 and all the way along the peripheral walls. Each of the closing members is provided such that its downward movement is restricted while its upward movement is unrestricted and such that it projects downwardly from lower end portion of the cover member 22. And the lower end portion of the cover member 22 can be deformed by virtue of the fact that each of the plurality of closing members is raised upwardly by contacting the top surface of the article support platform 4.

In addition, when the top surface of the article support platform 4 is flat, the deformable member 26 may not have to be provided in the lower end portion of the cover member 22 so that the lower end portion of the cover member 22 is not deformable in the vertical direction.

(5) In the embodiment described above, the perforated plate-shaped members 33 are provided to cover the lower end surface of the blower 23. However, it is not necessary to provide the perforated plate-shaped members 33. In addition, the shape of the holes in the plate-shaped members 33 may be changed suitably. A metal plate with many circular holes punched through or with a number of slit-shape holes may be used.

(6) In the embodiment described above, the receiver 36 which receives the unload complete information from the transport controller H1 is provided as a move detecting device. However, as a move detecting device, a position sensor may be provided which detects the position of the cleaning apparatus 5 with respect to the article support platform 4, such as a contact sensor which is turned on as the cleaning apparatus 5 is transferred to the article support platform 4.

(7) In the embodiment described above, the operation of the fan filter unit F is stopped after a set period has elapsed since the fan filter unit F is started. However, dust concentration measuring device, such as a particle counter, may be provided in the cleaning apparatus 5. And the operation of the fan filter unit F may be stopped or suspended when the concentration of dust within the cover member as measured by the dust concentration measuring device falls below a threshold value after the operation of the fan filter unit F is started.

(8) In the embodiment described above, the article transport vehicles are the ceiling transport vehicles 1 which travel along the travel rail 2 provided on the ceiling side and the support member is vertically moved by feeding out and spooling the spool belts 15a. However, the article transport vehicles may be stacker cranes provided on the floor side and the support member may be vertically moved by raising and lowering a vertically movable platform.

(9) In the embodiment described above, the cleaning apparatus 5 is received from the article support platform 4 by an article transport vehicle that is different from the article transport vehicle that unloaded the cleaning apparatus 5 onto the article support platform 4. However, the cleaning apparatus 5 may be received from the article support platform 4 by the same article transport vehicle that unloaded the cleaning apparatus 5 onto the article support platform 4.

Incidentally, one cleaning apparatus 5 may be provided in an article transport facility, or more than one may be provided. Description of Reference numerals and Symbols
1 Article Transport Vehicle
2 Travel Rail
5 Article Support Platform
6 Article
14 Support Member
21 Supported Member
22 Cover Member
23 Blower
24 Dust Collector
28 Dust Filter
29 Ventilating Fan
30 Dust Collection Space
33 Plate-shaped Member
35 Battery
36 Transfer Detection Device
E Cleaning Target Location
F Fan Filter Unit
H2 Controller
S0 Exterior Space
S1 Interior Space

1. A cleaning apparatus including a supported member adapted to be supported by a support member of an article transport vehicle, the support member being configured to support an article and to place the article supported by the support member on an article support platform when the support member is lowered, the cleaning apparatus being configured to clean a cleaning target location on a top surface of the article support platform with the cleaning apparatus placed on the article support platform as a result of a lowering of the support member with the supported member supported by the support member, the cleaning apparatus comprising:
a cover member which covers the cleaning target location of the article support platform;
a blower which moves air toward the cleaning target location within an area surrounded by the cover member while the cleaning target location is covered by the cover member; and
a dust collector which collects dust that is lifted by movement of air caused by the blower.

2. The cleaning apparatus as defined in claim 1, wherein
the dust collector is located in dust collection space defined above the blower, wherein
the blower is configured to draw in air from the dust collection space to cause the air to pass through the dust collector and to move the air toward the cleaning target location located below the blower, and wherein
an air guiding path is provided for guiding the air moved toward the cleaning target location through an area lateral of the blower and to the dust collection space.

3. The cleaning apparatus as defined in claim 1, wherein
a lower end portion of the cover member is configured to be deformed to conform to a shape of a top surface of the article support platform in order to block off interior space of the cover member from exterior space.

4. The cleaning apparatus as defined in claim 1, wherein
the blower is a fan filter unit having a dust filter for removing dust and a blower fan for moving air toward the cleaning target location through the dust filter wherein the dust filter and the blower fan are assembled into an integral unit.

5. The cleaning apparatus as defined in claim 1, wherein
the blower includes a blower fan which is rotated about a vertical axis wherein the blower is located at a position spaced apart upwardly from the cleaning target location when the cleaning apparatus is placed on the article support platform, and wherein
a lower end surface of the blower is covered with a perforated plate-shaped member.

6. The cleaning apparatus as defined in claim 1 further comprising:
a controller for controlling operation of the blower;
a battery for supplying electric power to the blower; and
a move detecting device which detects that the cleaning apparatus has been moved onto the article support platform;
wherein the controller controls the blower in order to start an operation of the blower when the move detecting device detects that the cleaning apparatus has been moved onto the article support platform and to stop the operation of the blower after a set period has elapsed since the start of the operation of the blower.
